(19) United States
(12) Patent Application Publication
(10) Pub. No.: US 2025/0124376 A1
(43) Pub. Date: Apr. 17, 2025

(54) SYSTEM AND METHOD FOR CHILD ADOPTION INFORMATION AND SUPPORT

(71) Applicant: Courtney Mull, Morganton, NC (US)

(72) Inventor: Courtney Mull, Morganton, NC (US)

(21) Appl. No.: 18/915,041

(22) Filed: Oct. 14, 2024

Related U.S. Application Data
(60) Provisional application No. 63/589,698, filed on Oct. 12, 2023.

(51) Int. Cl. G06Q 10/0631; G06Q 50/22; G06Q 50/26

(52) U.S. Cl. CPC G06Q 10/06313; G06Q 50/22; G06Q 50/26

(57) ABSTRACT

A system and method for information and support in child adoption. The system through an interface implemented on a user device can guide the birth mother and adoptive parent through the journey of child adoption from the beginning to the end. The interface may include different screens that can provide guidance and information about different aspects of child development, pregnancy, and adoption.

### CROSS-REFERENCE TO RELATED APPLICATIONS

This application claims priority from a U.S. Provisional Patent Appl. No. 63/589,698, filed on Oct. 12, 2023, which is incorporated herein by reference in its entirety.

### FIELD OF INVENTION

The present invention relates to a system and method for child adoption information and support, and more particularly, the present invention relates to a system and method for assisting individuals in a complete journey of child adoption.

### BACKGROUND

Navigating the intricate landscape of adoption can be a profoundly challenging journey, both for adoptive families and birth mothers. Often, they find themselves in uncharted territory, lacking the immediate social support network that can offer guidance and understanding during this emotionally charged process. The quest for information through online research or printed materials can become an exhausting and isolating endeavor. Moreover, historical assumptions about adoption can be a roadblock-introducing biases and fears around pursuing it. Thus, individuals face a lot of challenges in the adoption process. Often poor guidance results in unfavorable or undesired decisions. Individuals often get professional guidance in the adoption process from consultants and agencies. However, the fees of such professional consultations are quite high, and finding a good consultant can become another tedious task.

A need is therefore appreciated for a system and method for child adoption information and support, preferably in the form of a mobile application.

### SUMMARY OF THE INVENTION 2920

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method that can revolutionize the way individuals navigate adoption and provide the much-needed information, support, and clarity in their path forward. The system and method can be implemented in the form of a smartphone application designed to connect adoptive parents and birth mothers to education and support networks relating to the adoption process. It helps educate those actively waiting for a child's birth on its expected prenatal development.

Another object of the present invention is that the system conveniently links the viewer to accredited sources of information, helping them grow their families through adoption. It conveniently links birth mothers to accredited sources to make an adoption plan for their children.

Still, another object of the present invention is that the system is easily accessible to the general population.

Yet another object of the present invention is that the system can provide cost-effective solutions for many.

A further object of the present invention is that the system bridges adopting parent and birth mothers on how to think of adoption and explain the decision to their child and others.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing the environment of the system, according to an exemplary embodiment of the present invention.

FIG. 2 is a block diagram showing the architecture of the system, according to an exemplary embodiment of the present invention.

FIG. 3 shows a main menu screen of the interface, according to an exemplary embodiment of the present invention.

FIG. 4 shows a settings screen of the interface, according to an exemplary embodiment of the present invention.

FIG. 5 shows a home screen of the interface, according to an exemplary embodiment of the present invention.

FIG. 6 shows a child screen of the interface, according to an exemplary embodiment of the present invention.

FIG. 7 shows an adoptive parent screen of the interface, according to an exemplary embodiment of the present invention.

FIG. 8 shows a birth mother screen of the interface, according to an exemplary embodiment of the present invention.

FIG. 9 shows a resources screen of the interface, according to an exemplary embodiment of the present invention.

FIG. 10 shows a child development screen of the interface, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed are a child adoption information and support method and system that can guide and help people in the child adoption process. The disclosed system and method can assist people directly or indirectly involved in a child adoption process from beginning to end. The beginning includes when adoptive parents are considering adoption, and the end process includes the after-adoption care of an adopted child. The disclosed system can bring the would-be parties into an adoption process through guidance and support. The system allows the parties to know the next steps and prepare them in advance. Unlike in-person help, the disclosed system can be accessible through a user device, such as a smartphone or laptop. Such accessibility makes the invention more versatile and cost-effective.

The disclosed system can bring openness, pride, guidance, and support to both parties considering adoption. Such parties may include the adoptive parents and birth mothers. The way adoptive parents and birth mothers view each other determines their child's future self-image. By proper education and guidance, the system may assist in promoting the growth of the child to be one of self-acceptance, self-confidence, and love for both parties. The disclosed system can include comprehensive information about the adoption process, wherein such information may be fully authenticated. There can be differences in people's beliefs, laws, and procedures from state to state. So, the system can include all such information and utilize the same on a case-by-case basis.

The disclosed system not only assists in the adoption process but also provides emotional support like a virtual assistant. The system helps in reducing any biases and fears between the parties. With the help of the disclosed system, the parties in the adoption process are more confident and feel empowered.

The disclosed system may take into consideration different cases and scenarios including adoptive parents who have experienced infertility and loss. Current known pregnancy applications (describing prenatal development) are exclusively oriented toward a pregnant couple expecting a child. The disclosed system can provide a virtual experience of prenatal development to the adoptive parent, taking into consideration the possibility of previous infertility and this child developing in another woman's womb. For Birth Mothers, the disclosed system can help with managing emotions during pregnancy, for example, the difficult emotions a birth mother may be considering with an unplanned pregnancy.

The advantage of the present invention is understanding the requirements of an individual relating to a child's adoption process and providing accurate resources that empower them to make informed decisions. It allows the adoptive family to experience the joy of planning for their child's arrival.

The disclosed system can be used by prospective adoptive parents seeking information and guidance. The disclosed system can also be used by couples and individuals navigating through the complex adoption process. The disclosed system can be used for those looking for emotional support during the adoption journey.

Birth mothers considering adoption must go through difficult emotions as well as the psychological changes of pregnancy. Such birth mothers seek resources and understanding throughout the adoption process. The disclosed system can provide both emotional support and guidance.

Besides adoptive parents and birth mothers, the professionals and agencies providing consultations in the adoption process can also use the disclosed system to enhance their support services and streamline the process. Similarly, support groups and communities playing any role in the adoption process may also benefit from the disclosed system. The system can provide general knowledge, specialized knowledge, legal knowledge, and guidance depending upon a case, or stage in an adoption process.

The disclosed system may also provide community support for the parties, wherein they can connect with others facing similar challenges. Through community, people can connect with others to share their experiences and emotions. Often, birth mothers may feel lonely and have an urge to speak with others. The disclosed system can provide both online and offline social meetings with other like-minded people or those looking for a sense of belonging and shared experiences.

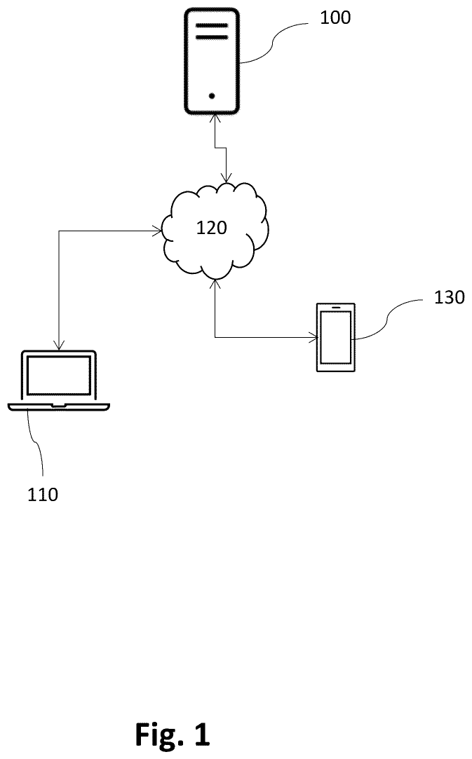

Referring to FIG. 1, a block diagram showing an environment of the disclosed system 100. System 100 can connect to a first user device 110 through a network 120. The term “user” as used herein, and throughout this disclosure, refers to an individual engaging a user device to interact with the system. The user can be a birth mother, adoptive parent, any organization, agency, and the like. Thus, the term user device encompasses devices of individuals and agencies. The user device can be any computing device that includes a processor for processing instructions stored in memory. The user device can also include an input module for receiving input from the user. Such input can be in the form of a touch display, mouse, stylus, keyboard, touchpad, and the like. The user device may also include a display for presenting information to the user, for example, an LCD screen. The user device may also include a network circuitry for connecting to the network 120. Examples of the user device include a smartphone, a desktop computer, a laptop, a workstation, and the like.

The network can be a communication network known in the art which can be a wired network, a wireless network, or may include a combination of wired and wireless networks. Examples of communication networks may be a local area network (LAN), a wide area network (WAN), a wireless WAN, a wireless LAN (WLAN), a metropolitan area network (MAN), a wireless MAN network, a cellular data network, a cellular voice network, the Internet, etc. While, for illustration herein, FIG. 1 shows a single network connecting a user device, it should be obvious to those reading this disclosure that different user devices can connect with the system through various networks, and the same user device can connect with the system through more than two networks. For example, a user device can connect to the system through a LAN and the Internet.

FIG. 1 shows a second user device 130 also connected to the system 100 through the network 120. The first user device 110 and the second user device 130 can communicate with each other through the system. The first user device can be of a birth mother while the second user device can be of the adoptive parent.

The system can be implemented in the form of servers, which include cloud servers. The servers can be placed in one location or geographically dispersed. Also, one or more steps of the disclosed methodology can be performed on one or more user devices without departing from the spirit of the disclosed subject matter.

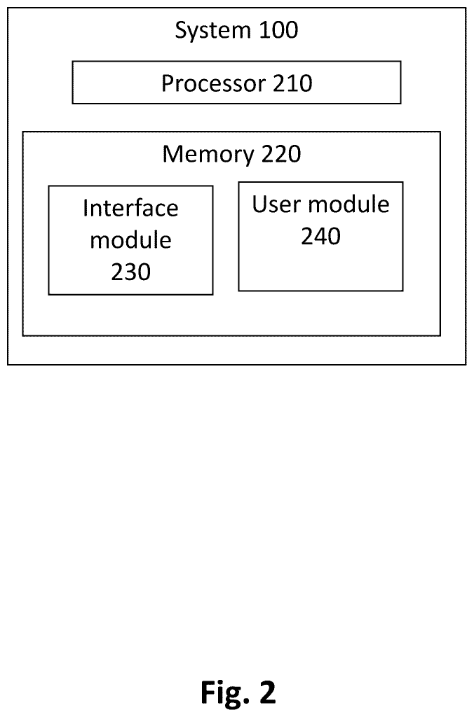

Referring to FIG. 2 which is a block diagram showing an architecture of the disclosed system 100. The System 100 includes a processor 210 and a memory 220 operably coupled to the processor. The processor can be any logic circuitry that responds to, and processes instructions fetched from the memory. The memory may include one or more memory chips capable of storing data and allowing any storage location to be directly accessed by the processor. The memory can include modules according to the present invention for execution by the processor to perform one or more steps of the disclosed methodology.

The module as used herein and throughout this disclosure refers to software, a program code, a set of rules or instructions, and the like in one or more computer-readable languages including graphics, which upon execution by the processor performs one or more steps of the disclosed methodology. Also, operations may be described as a sequential process, some of the operations may be performed in parallel, concurrently, and/or in a distributed environment, and with program code stored locally or remotely for access by single or multi-processor machines. In addition, in some implementations, the order of operations may be rearranged without departing from the spirit of the disclosed subject matter.

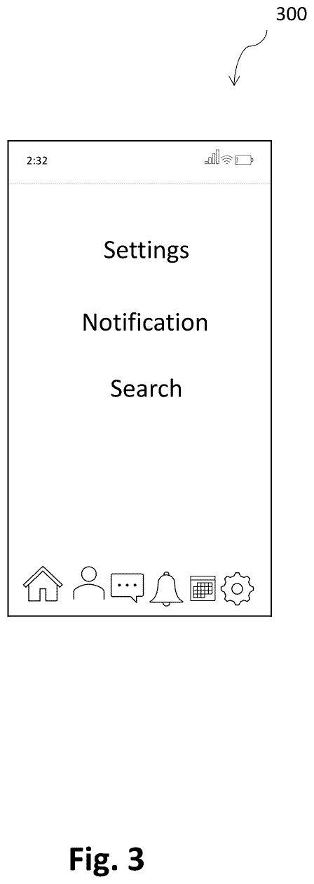

The memory may include an interface module 230 which upon execution by the processor can provide an interface on a user device for interacting with the system. The interface provided by the interface module allows a user to interact with the disclosed system through a user device. The interface may include a series of screens, as shown in FIGS. 3-10, which in continuation can provide information as well as receive information from the user and execute one or more steps of the disclosed methodology. The interface can be dynamic and allows switching between sections, screens, pages, and the like quickly and easily. The interface can be provided as an application software that can be installed on the user device. The application software can be developed for Android™, iOS, and any other known operating platform for mobile devices. The application software can be made available through a distribution service provider, for example, Google Play™ operated and developed by Google, and the app store by Apple. In addition to the application software, a website-based interface can also be provided through the World Wide Web. The application software can also be provided for the desktop environment, such as Windows™, Linux, and macOS. The user interface may permit interaction with a user through the user device, wherein information can be presented within the user interface by system 100 and information can be received by system 100 from the user.

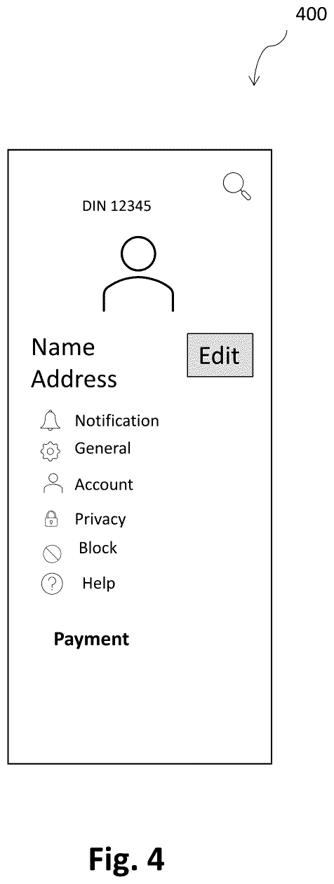

The disclosed system may also include a user module 240 that may allow an individual to register with the disclosed system 100. The user module can receive basic information about the individual, such as name, contact details, email address, address, and the like to sign up the user. The user module can generate a profile for the user and store the same in a suitable database. The databases, including their structure and functioning, are known in the art. Also, the use of blockchain databases is well known. The present invention can use any suitable database without departing from the scope of the present invention. Also, the profile created by the user module can be later modified by the user. For example, FIG. 4 shows a settings screen 400 including a photograph of the user. Below the photograph frame is the name and location of the user. Adjacent to the name is an icon “Edit” that may open another screen showing the profile as a form. The user has the option to edit entries or add more information, and the user module can update the respective profile in the database.

The user module can generate login details to access the disclosed system securely. The login details may include at least a username and a password. The password can be an alphanumeric code, or a biometric like a fingerprint, token, and the like. The user may have multiple login options, such as using an alphanumeric code or a fingerprint. Also, the use of multiple-factor authentication is within the scope of the present invention. A login screen can be rendered on the user device for accessing the disclosed system.

Some information from the profile generated by the user module for the respective user can be used to generate a public profile. The public profiles can be visible to other users of the system. In certain implementations, the public profile may include a photograph, name, and brief description of the user. The public profile may also include location information. The public profile may also include options for contacting other users via messages and calls.

Referring to FIG. 3, which shows a main menu screen 300 that includes the links for settings, notifications, and a search interface. Clicking the setting link from the main menu screen opens the settings screen 400 shown in FIG. 4. The settings screen 400 may allow the user to edit profile information, change login details, review account details, block and unblock users, notification settings, changing privacy settings, and the like. A help menu can also be included that helps the user to navigate different options. A payment option can also be included that may be linked to a suitable payment interface for making the payments. Clicking the notification link on the menu opens a notification screen. The notification screen can show updates on the user and the other users linked with the respective users.

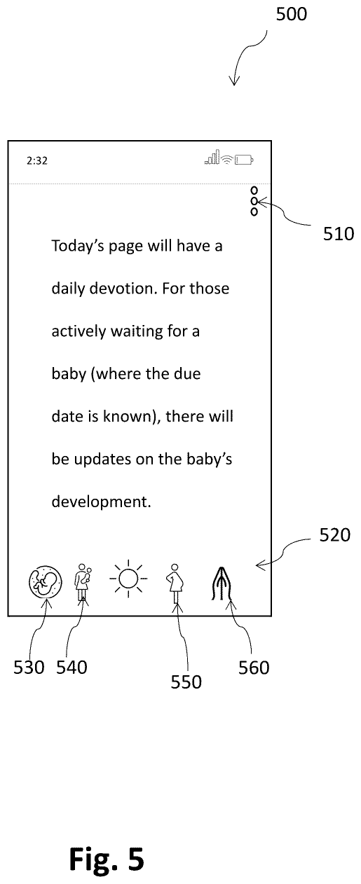

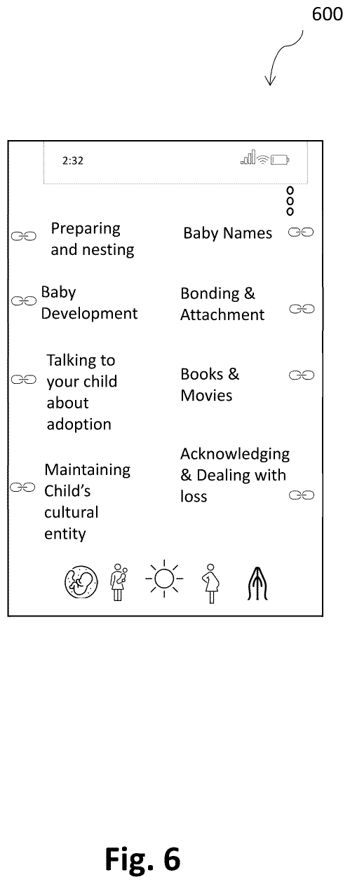

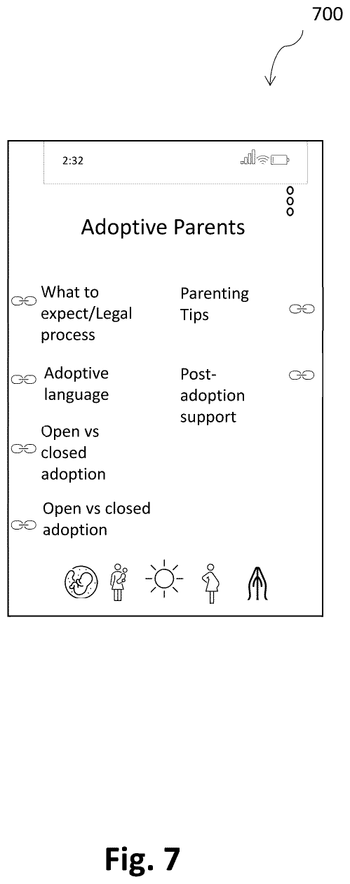

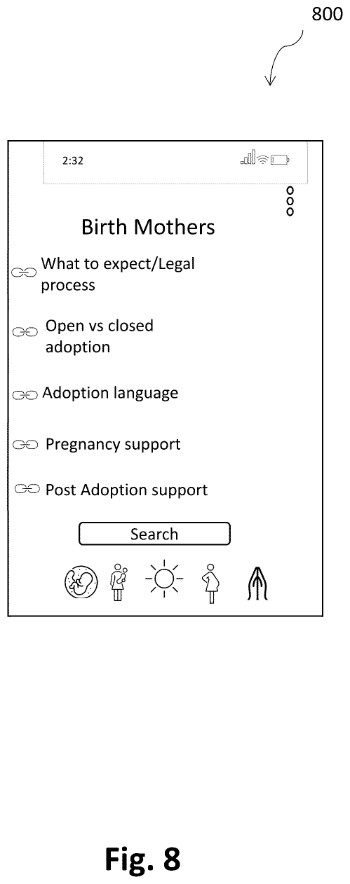

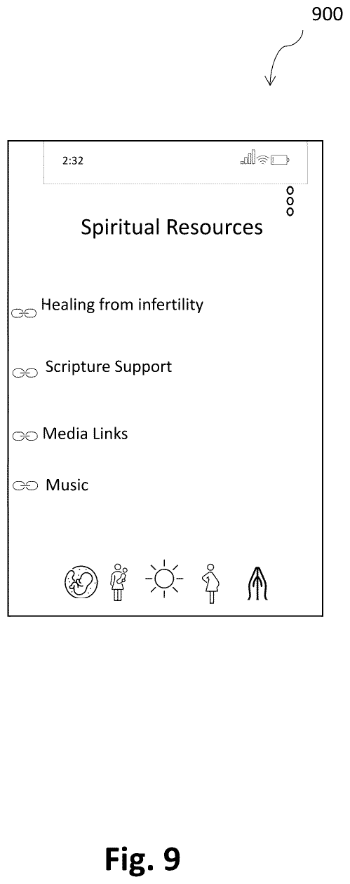

When the user logs into the disclosed system 100, the user can be presented with a home screen 500 as shown in FIG. 5. The home screen 500 may include a link in the form of three dots 510 for the main menu screen 300, shown in FIG. 5. A navigation bar 520 can be provided at the bottom of screen 500 that allows access to different menus and options implemented by the disclosed system 100. The first icon 530 in the navigation bar 520 opens a child screen 600 shown in FIG. 6. A second icon 540 in the navigation bar 520 opens the parent screen 700 shown in FIG. 7. A fourth icon 550 in the navigation bar 520 opens the mother screen 800 shown in FIG. 8. A fifth icon 560 opens the resources screen 900 shown in FIG. 9.

Referring to FIG. 6 shows the child screen 600 which may provide various resources useful in child development. Clicking the first option “preparing & nesting” opens a screen that provides information for preparing and nesting a child i.e., an adopted child. The screen shows various tips to help a parent get ready for parenthood. The screen provides information about stages of child development, parenting techniques, and medical advice to be taken, such as from an obstetrician. The child screen 600 may also allow a user to plan a budget and keep track of expenses. The child screen 600 may guide the user through the pregnancy process and childbirth. The user can then easily differentiate between normal and abnormal pregnancy conditions, and what may require medical attention. The system may help the user build a support network of friends and family in an organized manner. For example, the support network may include people who can provide emotional support to the user and people who can provide practical support during pregnancy.

The child screen also allows the user to monitor the child's development. The system can connect with the medical records of the user and fetch details related to child development. The system, through the interface, can present multiple sonograms of the different months to show the child's development over the months.

Another option “talking to your child about adoption” helps the child understand adoption in a healthy way. It may provide all the instructions and guidelines about talking to the child in a more sensitive manner. The child can be taught about adoption at a young age so that it becomes a natural part of their understanding of their family. The disclosed system can guide using authenticated and well-crafted information keeping in mind the young age of a child.

An important point most parents miss in child development is cultural education. It may be important to maintain a child's cultural identity, especially if they have diverse cultural backgrounds. The user can access books, stories, and educational material that showcase their cultural identity. The child can learn about traditions, history, and values that are both educational and empowering. The disclosed system can understand the culture of a family through questions and observations and could automatically fetch and customize the child's information. The system can also inform the caregiver or parent of the child about the cultural events happening around. This eases the life of the caregiver, as the system can perform most of the tasks itself.

The child screen may also provide an option to view baby names. Thinking the name of a child is quite important for parents and they often seek suggestions in naming the child. The process often becomes time-consuming and tedious. The disclosed system can take care of this aspect of child development as well by providing a list of suitable names directly from the child screen 600. The names can be sorted based on ethnic, cultural, or historical heritage.

Bonding with the child is the most important aspect of the adoption process. The disclosed system can prepare the parents for this important step by providing widely proven methods for strengthening their connection with a child.

Grief is also a strong emotion that can be encountered by both birth mothers and adoptive parents in the adoptive process. Dealing with a loss can be incredibly challenging, requiring emotional support. The disclosed system can heal this aspect of life as well. The system can provide tips to help cope with grief and navigate the healing process.

Books are an important source of information, and several books have been written on adoption. The disclosed system can include e-books and digital editions of a well-curated collection of books on adoption. The system can also provide suggestions for the user.

Referring to FIG. 7 which shows the parent screen 700 for adoptive parents. Generally, the first step in the adoption process is to know the legalities of adoption. The disclosed system can walk the customer through the legal process. The disclosed system can explain legal jargon to the user. Also, dealing with legal issues involving adoption can be complex and emotionally charged. The invention disclosed allows the user to approach these matters with careful consideration. The system can present a stepwise process to help the user go through all the legalities easily and efficiently.

Another feature of the parent screen is educating the user about the open and closed approaches to adoption. The system can help differentiate between the two for better understanding so that the user can understand the relationship options.

The mother screen can also help the user to find resources and support during pregnancy. There are various valuable websites and organizations that can provide valuable information and physical assistance to birth mothers. The disclosed system can streamline authenticated and reputable resources and make suggestions to the user based on the needs of the user.

Post-adoption support is crucial for adoptive families as they navigate the unique challenges and joys of adoptive parenting. The disclosed system can provide various resources in the form of information, adoptive agencies, and professionals. The system can suggest any based on the problems faced by the user. The system can make suggestions for adoptive agencies and professionals and assist in reaching out to selected agencies or professionals. Also, the disclosed system can provide online communities and support groups in which the user can take part. The system can also help connect the user with external platforms and communities.

Referring to FIG. 9 shows a resource screen 900 that includes various other resources for the users. These resources can be for both the adoptive parents and birth mothers. The first resource on the screen is “Healing from infertility” which could help people who have infertility issues. Healing from infertility can be a challenging and emotional journey. The disclosed system can guide the user through a stepwise healing process that may include grieving, seeking support, and professional help.

The resource screen may also list various websites, blogs, podcasts, books, and the like that may be useful to the user. The system can provide a brief description of each resource that may already be organized according to topics and ratings. This may help the user navigate these resources quickly and find what is needed.

Music is well known for healing and is included in the resource screen. The system can include a curated collection of music that may aid in relaxation and healing. The user does not have to look here and there for suitable music collections but can have access to the curated collections right through their mobile interface. Besides music, other media links, such as videos, games, and the like can also be included, wherein links to such resources can be provided on another screen of the interface.

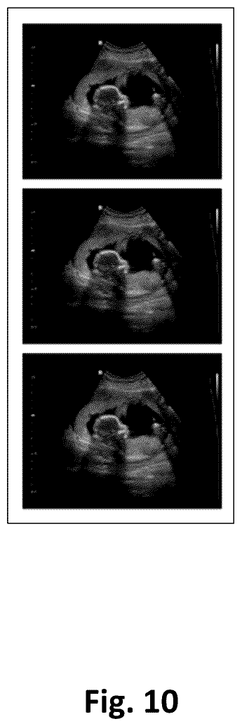

FIG. 10 shows a child development screen in which the system can fetch sonograms of the fetus and store them as a record with a date. The system may render different sonograms for presenting to the user through the child development screen. The sonograms are arranged according to the date so that child development over months can be presented. Also, instead of ultrasound, the disclosed system can use prenatal development information and computer models to demonstrate the child's development.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for child adoption information and support, the system comprising a processor and a memory, the system configured to implement a method comprising:
rendering an interface on a user device, wherein the interface comprises:
a main menu screen comprising links for a settings screen, a notifications screen, and a search screen;
the settings screen is configured to allow a user to edit profile information, change login details, review account details, block and unblock users, change notification settings, and change privacy settings;
the notifications screen is configured to present updates to a user;
a child screen configured to provide resources useful in child development and to guide the user through pregnancy process and childbirth;
a parent screen for adoptive parents configured for providing legal information and terminology related to adoption; and
a resources screen configured to provide different resources to the user.

2. The system of claim 1, wherein the method further comprises:
guiding and supporting would-be parties in an adoption process.

3. The system of claim 1, wherein the user device is a smartphone.

4. The system of claim 2, wherein the would-be parties comprise an adoptive parent and a birth mother.

5. The system of claim 1, wherein the method further comprises:
rendering a virtual assistant on the user device, wherein the virtual assistant is configured to provide emotional support and guidance to the user, wherein the user includes an adoptive parent and a birth mother.

6. The system of claim 1, wherein the child screen comprises:
preparing & nesting option configured to provide information for preparing and nesting a child;
tips to help a parent get ready for parenthood;
information about stages of child development, parenting techniques, and medical advice to be taken;
option to monitor development of the child, wherein the system is configured to fetch medical records of the user and the child;
tip to maintain cultural identity of the child;
baby names; and
resources including digital books and movies related to child development.

7. The system of claim 1, wherein the parent screen is configured to allow the user to differentiate between open and closed approaches to adoption.

8. The system of claim 1, wherein the interface is further configured to render a child development screen.

9. A method for child adoption information and support, the method implemented within a system comprising a processor and a memory, the method comprising:
rendering an interface on a user device, wherein the interface comprises:
a main menu screen comprising links for a settings screen, a notifications screen, and a search screen;
the settings screen is configured to allow a user to edit profile information, change login details, review account details, block and unblock users, change notification settings, and change privacy settings;
the notifications screen is configured to present updates to a user;
a child screen configured to provide resources useful in child development and to guide the user through pregnancy process and childbirth;
a parent screen for adoptive parents configured for providing legal information and terminology related to adoption; and
a resources screen configured to provide different resources to the user.

10. The method of claim 9, wherein the method further comprises:
guiding and supporting would-be parties in an adoption process.

11. The method of claim 9, wherein the user device is a smartphone.

12. The method of claim 10, wherein the would-be parties comprise an adoptive parent and a birth mother.

13. The method of claim 9, wherein the method further comprises:
rendering a virtual assistant on the user device, wherein the virtual assistant is configured to provide emotional support and guidance to the user, wherein the user includes an adoptive parent and a birth mother.

14. The method of claim 9, wherein the child screen comprises:
preparing & nesting option configured to provide information for preparing and nesting a child;
tips to help a parent get ready for parenthood;
information about stages of child development, parenting techniques, and medical advice to be taken;
option to monitor development of the child, wherein the system is configured to fetch medical records of the user and the child;
tip to maintain cultural identity of the child;
baby names; and
resources including digital books and movies related to child development.

15. The method of claim 9, wherein the parent screen is configured to allow the user to differentiate between open and closed approaches to adoption.

16. The method of claim 9, wherein the interface is further configured to render a child development screen.
